(19) United States
(12) Patent Application Publication
(10) Pub. No.: US 2007/0164067 A1
(43) Pub. Date: Jul. 19, 2007

(54) Luggage connector and transport aid

(76) Inventor: Howard Francis Wright, Houston, TX (US)

Correspondence Address: HOWARD WRIGHT, 9122 GIANNA COURT, HOUSTON, TX, 77083, US

(21) Appl. No.: 11/333,113

(22) Filed: Jan. 16, 2006

(51) Int. Cl. A45F 3/14; B60R 9/00; B60R 7/00

(52) U.S. Cl. 224/401; 224/184

(57) ABSTRACT

The invention is a device used to assist in the transport of small, carry-on, wheeled luggage. The connector can be used to connect two pieces of wheeled, carry-on luggage together, allowing them to be conveyed easily at the same time by one passenger. Also, the connector can connect to one piece of wheeled carry-on luggage, with the other side connecting to the clothing of a passenger, allowing the passenger to convey the luggage with both hands free.

### CROSS REFERENCE

None

### BACKGROUND OF THE INVENTION

Travelers have always wrestled with the problem of luggage. If a traveler brings too little, they may have left needed items at home; if they bring too much, they are burdened with cumbersome bags that make travel slow and uncomfortable. Many passengers nowadays used wheeled luggage, including luggage that is specifically made to be brought on board aircraft, trains, or buses. This so-called “carry-on” luggage is the luggage passengers personally transport the most, as this luggage is carried on and off during connections, while the heavier, checked baggage is sent straight to the passenger's destination.

While this baggage has been manufactured for the passenger's convenience, containing wheels and a retractable handle, it can still cause problems for a traveler. For example, a parent will often need to convey not only their own luggage, but also their children's. Conveying two pieces of luggage simultaneously can be almost impossible, as the two pieces will not move forward uniformly. If the two pieces of luggage are pulled directly behind the passenger, one in each hand, they are too close together, and will bump into each other, causing one or both to roll onto its side and off of its wheels. If the passenger tries to hold the two pieces in such a way that they are separated, this causes a different problem. As long as the passenger holds his or her arms up and away from the body, keeping the luggage handles parallel to each other, the luggage will move forward in the same direction as the passenger. However, if the passenger becomes tired and the passenger's arms drop toward the body, this causes the luggage to move in an angle relative to the passenger, instead of forward. This will, once again, cause the luggage to roll onto its side, and off of its wheels. While it is still possible to convey the luggage, a passenger will constantly need to stop and adjust the luggage so it is on its wheels and moving forward. A person conveying one piece of luggage does not have this same problem, but is still only left with one free hand. A passenger who is carrying a non-wheeled bag, or an article such a bedroll, or is carrying a child, is forced to stop and switch arms as the arm with the heavier burden becomes tired. What is needed is a device that will allow a passenger to convey two pieces of luggage efficiently and conveniently. This device should also allow passengers' to carry one piece of luggage hands-free.

### SUMMARY OF THE INVENTION

The first purpose of the invention is to provide a device that will allow two pieces of small, wheeled, carry-on luggage to be connected, allowing for ease of transport.

The second purpose of the invention is for the device to consist of a solid plastic cylindrical rod, which will rest in between the two pieces of luggage when they are connected. The rod will serve the purpose of stabilizing the two pieces of luggage, so that they maintain the same distance from each other, and keep the sides of the luggage facing. This allows the luggage to move forward without weaving around on the floor, and keeps the luggage from falling over. The rod is plastic to keep it lightweight, and also to avoid having it mistaken as a weapon.

The third purpose of the invention is to have a hook and latch arrangement on either side of the rod, which is used to connect the rod to the two pieces of luggage via the non-retractable side handles. The latches are large enough to accommodate a thick handle, and the hook and latch are secure enough that the device will not fall off during use. The latch is also easy enough to move that it does not need a great deal of force to open it, allowing anyone (e.g., elderly or infirm passengers) to use it.

The fourth purpose of the invention is to have this device enable a passenger with one piece of luggage to transport the luggage hands-free through use of the device. The passenger can attach one hook and latch arrangement to the retractable handle of the luggage, and the other hook and latch to the passenger's clothing. The best choice, though by no means the only choice, is to attach the other hook and loop to the passenger's belt loop. The passenger will convey the luggage simply by walking, as the device will pull the luggage behind the passenger. The luggage will remain stable, as it is being conveyed the same way as if the passenger were holding the handle. This will also free both hands of the passenger for other activities.

The fifth purpose of the invention is to provide a method of conveying two pieces of carry-on luggage simultaneously in a convenient manner, in the method just described.

The sixth purpose of the invention is to provide a method of conveying one piece of carry-on luggage hands-free, in the method just described.

The seventh purpose of the invention is for the device to be convenient for the passenger, as it can be stored in the passenger's luggage when not in use, and to provide ease of care, as it can be wiped clean with a damp cloth.

### BRIEF DESCRIPTION OF THE DRAWINGS

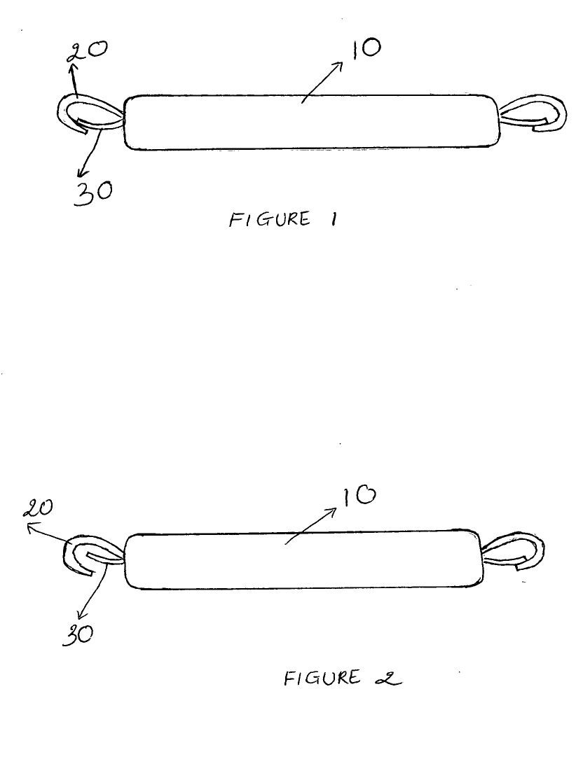

1. FIG. 1 is a side view of the device, with both hook and latch arrangements closed.

2. FIG. 2 shows the same side view of the device, with one of the hook and latch arrangements open.

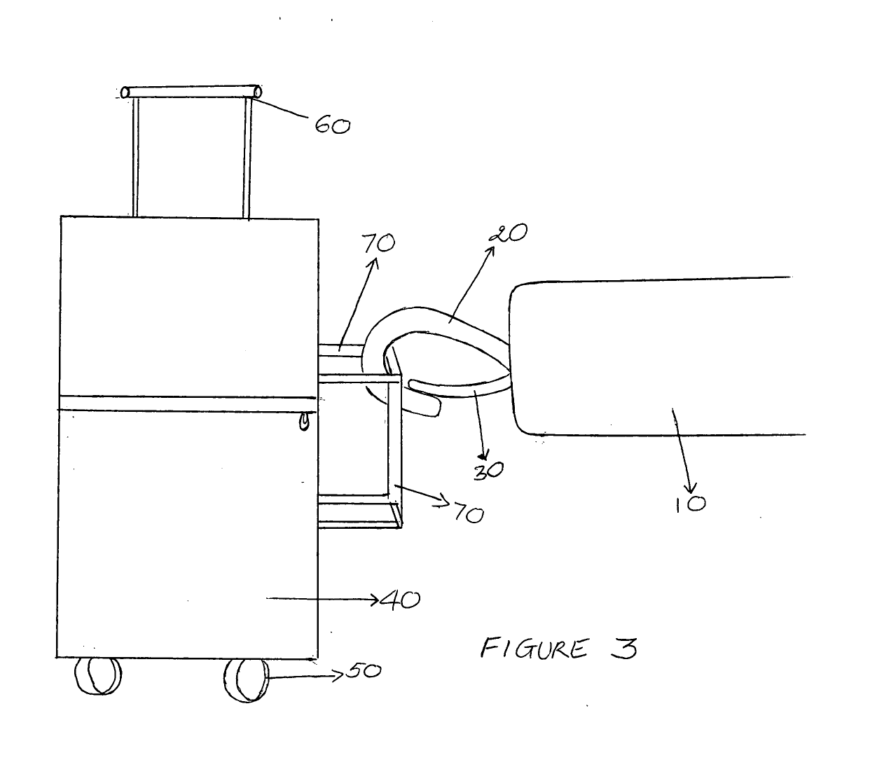

3. FIG. 3 shows a detail of one end of the device connected to a piece of carry-on luggage.

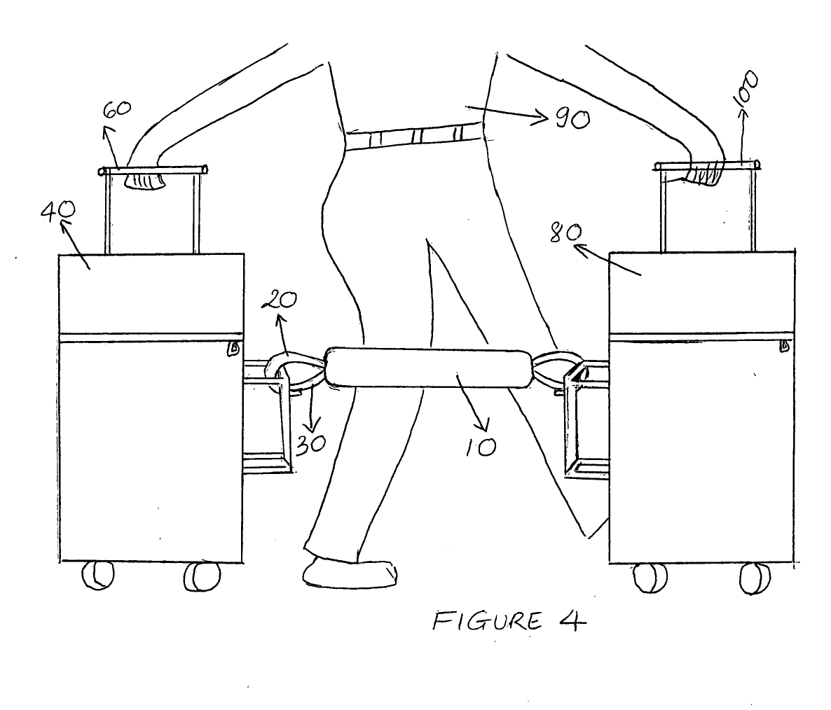

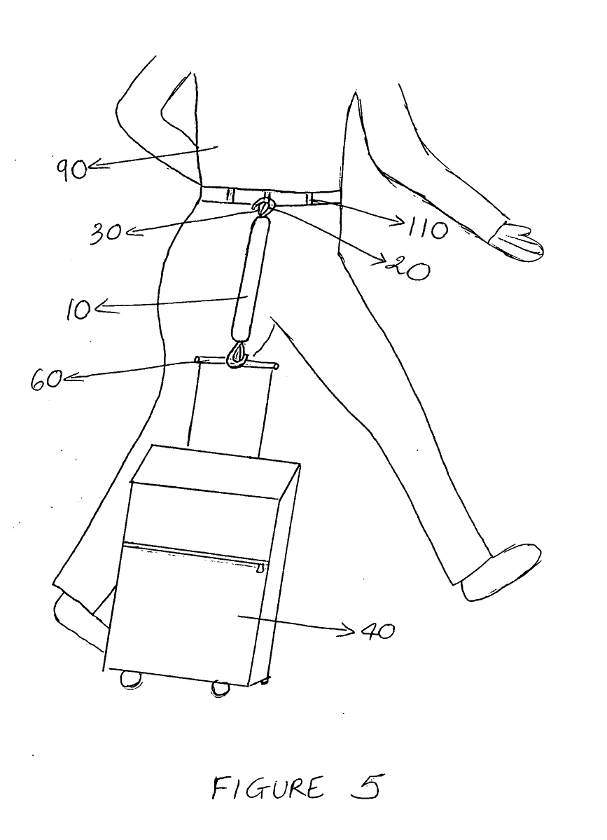

4. FIG. 4 shows a passenger conveying two pieces of luggage which have been connected together using the device.

5. FIG. 5 show a passenger conveying one piece of luggage by using the device to connect the luggage to the passenger's clothing.

### DETAILED DESCRIPTION OF A PREFERRED EMBODIMENT OF THE PRESENT INVENTION

1. FIG. 1 shows a side view of the device, with its solid cylindrical rod 10 containing hook 20 and latch 30 attachments on either side. In this illustration, both of the hook 20 and latch 30 arrangements are in the closed position, which is the position they are in when the pieces of luggage have been attached using the device.

2. FIG. 2 shows the same view of the device, with the hook 20 and latch 30 arrangement open on one side. The hook 20 and latch 30 arrangement are large enough to accommodate a variety of luggage handles. In addition, the latch 30 is easy to open, but will close completely, ensuring the device will not come loose once the two pieces of luggage are connected.

3. FIG. 3 shows a detail of the device being connected to a piece of carry-on luggage. When the luggage 40 is resting on the luggage wheels 50, the retractable handle 60 in on top of the luggage 40, directly opposite to the luggage wheel 50. On the side of the luggage 40 is another, non-retractable side handle 70. The hook 20 is attached to this side handle 70, and the latch is placed in the closed position. The rod 10 will then extend to another piece of luggage. In this illustration, only a portion of the rod is visible.

4. FIG. 4 shows the device being used by a passenger with two pieces of luggage. The luggage 40, visible in FIG. 3, is connected to the device via the side handle to the hook 20 and latch 30 arrangement, with the latch 30 in the closed position. The hook 20 and latch 30 arrangement are attached to the rod 10, which has at its other end another hook 20 and latch 30 arrangement, which is then used to attach the device to a second piece of luggage 80 through the same method as the first piece. In this illustration, the passenger 90 is walking forward, holding the retractable handle 60 of the first piece of luggage 40 in the left hand, and the retractable handle 100 of the second piece of luggage 80 in the right hand. The rod 10 ensures that the two pieces of luggage maintain a constant distance from each other, and also allows the luggage to stabilize each other, to prevent either piece of luggage from tipping over. The rod 10 is solid enough to resist bending or breaking from the pressure exerted on it by the luggage. In addition, the hook 20 and latch 30 arrangements are attached securely to the rod 10, preventing them from becoming dislodged during use.

5. FIG. 5 shows the device being used by a passenger with one piece of luggage. The method of using the device to convey one piece of luggage hands-free is different from the method to convey two pieces. The hook 20 and latch 30 arrangement are attached to the retractable handle 60 of the luggage 40. The rod 10 has another hook 20 and latch 30 arrangement on its other side. This hook 20 and latch 30 arrangement are attached to the clothing of the passenger 90. In this illustration, the passenger 90 is walking forward, with both hands free. The belt loop 110 of the passenger 90 is attached to the rod 10 through the hook 20 and latch 30 arrangement. The hook 20 and latch 30 arrangement on the other side of the rod 10 is attached to the retractable handle 60 of the luggage 40. The device allows the luggage 40 to be conveyed forward efficiently and conveniently, allowing the passenger 90 to have the hands free for other tasks.

While the invention has been particularly described and illustrated with reference to the preferred embodiment thereof, it will be understood by those skilled in the art that changes in form and detail may be made without departing from the spirit and the scope of the invention.

What is claimed is:

1. A device which will aid in the transport of small, carry-on, wheeled luggage, comprising essentially:

2. The device as stated in claim 1, consisting of a solid plastic cylindrical rod, the rod being lightweight and easy to carry, while being strong enough to be used to convey wheeled luggage;

3. The device as stated in claim 1, further consisting of a hook and latch arrangement on opposite sides of the rod, which allows the device to be used to connect two pieces of luggage together.

4. The hook and latch arrangement as stated in claim 3, which further allows the device to be connected from a piece of luggage to the clothing of the passenger conveying the luggage;

5. The device as stated in claim 1, which can easily be stored in the luggage of the passenger, allowing for convenience of use while traveling;

6. The device as stated in claim 1, further being easy to maintain, as it can be wiped clean with a damp cloth;

7. A method for one passenger to convey two pieces of small, carry-on, wheeled luggage, through the use of the device to connect two pieces of luggage together;

8. A method for one passenger to convey one piece of small, carry-on, wheeled luggage hands-free, through use of the device to connect the luggage to the passenger's clothing, such as the belt loop.
